(19) United States
(12) Patent Application Publication
(10) Pub. No.: US 2009/0325118 A1
(43) Pub. Date: Dec. 31, 2009

(54) ORTHODONTIC BRACKETS HAVING A BENDABLE OR FLEXIBLE MEMBER FORMED FROM AMORPHOUS METALLIC ALLOYS

(75) Inventors: Paul E. Lewis, Midvale, UT (US); Neil T. Jessop, Sandy, UT (US)

Correspondence Address: Workman Nydegger;1000 Eagle Gate Tower, 60 East South Temple, Salt Lake City, UT, 84111, US

(73) Assignee: Ultradent Products, Inc., South Jordan, UT (US)

(21) Appl. No.: 12/488,076

(22) Filed: Jun. 19, 2009

Related U.S. Application Data
(60) Provisional application No. 61/076,264, filed on Jun. 27, 2008.

(51) Int. Cl. A61C 7/14

(52) U.S. Cl. 433/10

(57) ABSTRACT

Orthodontic brackets having a bracket base including at least one arch wire slot formed therein and a bendable or flexible member (e.g., a film hinge) having a relatively thin cross-sectional thickness to facilitate flexing or bending of the member with little or no permanent deformation, wherein at least the bendable or flexible member comprises an amorphous metallic alloy.

### RELATED APPLICATIONS

The present application claims the benefit of U.S. Patent Application Ser. No. 61/076,264, filed Jun. 27, 2008, entitled “ORTHODONTIC BRACKETS HAVING A BENDABLE OR FLEXIBLE MEMBER FORMED FROM AMORPHOUS METALLIC ALLOYS”, the disclosure of which is incorporated by reference in its entirety.

### BACKGROUND OF THE INVENTION

1. The Field of the Invention

The present invention relates to orthodontic brackets, more particularly to orthodontic brackets formed of metal.

3. The Related Technology

Orthodontics is a specialized field of dentistry that involves the application of mechanical forces to urge poorly positioned, or crooked, teeth into correct alignment and orientation. Orthodontic procedures can be used for cosmetic enhancement of teeth, as well as medically necessary movement of teeth to correct overjets or overbites. For example, orthodontic treatment can improve the patient's occlusion, or enhanced spatial matching of corresponding teeth.

The most common form of orthodontic treatment involves the use of orthodontic brackets and wires, which together are commonly referred to as “braces.” Orthodontic brackets, more particularly the bracket bases, are small slotted bodies configured for direct attachment to the patient's teeth or, alternatively, for attachment to bands which are, in turn, cemented or otherwise secured around the teeth. Once the brackets are affixed to the patient's teeth, such as by means of glue or cement, a curved arch wire is inserted into the slot of each bracket. The arch wire acts as a template or track to guide movement of the teeth into proper alignment.

There are two distinct classes of orthodontic brackets: those that require the use of ligatures to fasten the arch wire to the bracket, and those that are self-ligating. In brackets of the first class, small ligature wires are typically used to hold the arch wire in a securely seated position in the brackets. Ligatures or some other form of fastening means are essential to ensure that the tensioned arch wire is properly positioned around the dental arch, and to prevent the wire from being dislodged from the bracket slots during chewing of food, brushing of teeth, or application of other forces. One type of commercially available ligature is a small, elastomeric O-ring, which is installed by stretching the O-ring around small wings known as “tie wings” that are connected to the bracket body. Metal ligatures are also used to retain arch wires within the bracket slots.

In an effort to simplify the process of installing braces, a variety of self-ligating brackets have been developed. The term “self-ligating bracket” refers to a class of orthodontic brackets that include some sort of cover, whether separate from, hingedly or otherwise attached to the base, which encloses or otherwise retains the arch wire within the slot of the base.

Typically, brackets are formed from metal or ceramic as these materials provide much greater hardness and resistance to deformation, which characteristics are very important within an orthodontic bracket, particularly in the area surrounding the archwire slot. However, existing metal and ceramic self-ligating brackets must include at least two pieces (e.g., a base and separate cover) and require assembly.

Polymeric materials have been used in manufacture of orthodontic brackets, although they are less preferred by practitioners because of their lower hardness and tendency to deform during use. Still, polymeric materials do provide some benefits not possible with existing metal or ceramic brackets. For example, it is possible to injection mold a self-ligating bracket from a polymeric material where the bracket base and ligation cover are integrally connected to one another as a single piece by a flexible film hinge. Such a film hinge comprises a region of reduced cross-sectional thickness relative to the adjacent bracket base and ligation cover with which the film hinge is integral. Such a configuration allows manufacture of a single piece bracket by molding with no assembly required.

The flexible nature of polymeric materials makes such a connection mechanism possible. Examples of such brackets are disclosed in U.S. Pat. No. 6,960,081, which is incorporated herein by reference. The ability to form such a bracket as a single piece requiring no assembly is particularly advantageous as orthodontic brackets are very small and designs including multiple parts (e.g., particularly 3 or more) requiring assembly greatly increase complexity and cost. Still, because of the significantly lower strength and deformation resistance of polymeric materials, such brackets have not found wide acceptance within the market. Although U.S. Pat. No. 6,960,081 does mention that such brackets may be formed of a flexible metal material (e.g., nickel-titanium alloy), such materials require cold working in order to exhibit their super elastic flexible characteristics, so that it is not possible or at least practical to mold such a bracket from a flexible metal as a single piece.

### BRIEF SUMMARY OF THE INVENTION

The present invention is directed to orthodontic brackets having a bracket base including at least one arch wire slot formed therein, and at least one bendable or flexible member having a relatively thin cross-sectional thickness to facilitate flexing or bending of the member with little or no permanent deformation. At least the bendable or flexible member comprises an amorphous metallic alloy. Preferred orthodontic brackets are self-ligating, so that they include a ligation cover associated with the bracket base and selectively movable relative to the bracket base between an open, non-ligating position and a closed ligating position. In such brackets, the bendable and/or flexible member may comprise a film hinge interconnecting the bracket base with the ligation cover. The thinness of the bendable and/or flexible member formed of a glass-like amorphous metallic alloy surprisingly allows it to resiliently flex and bend, rather than fracture, as generally occurs using other types of metal.

Amorphous metallic alloys are characterized by an amorphous or at least substantially amorphous arrangement of alloy constituents, rather than the crystalline structure of traditional metallic materials. Such amorphous metallic materials would be expected, and do, exhibit brittle characteristics as compared to the ductile, malleable, and plastically deformable characteristics of traditional metals. Nevertheless, the inventors have discovered that, when formed so as to have very small cross-sectional thicknesses (e.g., those that may be employed in forming a film hinge or other bendable/flexible member), the amorphous metallic alloys unexpectedly exhibits a surprising degree of flexibility and bendability. At the same time, exemplary amorphous metallic alloys exhibit hardness and deformation resistance values even greater than traditional metals used in manufacture of orthodontic brackets. Such hardness and deformation resistance characteristics are particularly beneficial to the region of the bracket surrounding the arch wire slot.

According to one such embodiment, a self-ligating orthodontic bracket may be formed as a single integral piece (e.g., through injection molding the molten metallic alloy). No cold working or other manipulation of the metal material is required. Such a bracket may include a bracket base including at least one arch wire slot formed in the bracket base, a ligation cover that is selectively movable relative to the bracket base between an open non-ligating position and a closed ligating position, and an elongate bendable or flexible elongate film hinge attached at one end to the bracket base and at an opposite end to the ligation cover so as to hingedly connect the ligation cover to the bracket base. In an embodiment comprising a single integral piece, the whole bracket, including the film hinge, is formed of an amorphous metallic alloy, most preferably by molding.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary self-ligating orthodontic bracket including a bendable or flexible member in which the ligation cover is in an open, non-ligating position;

FIG. 2 is a perspective view of the bracket shown in FIG. 1 in which the ligation cover is in a closed, ligating position;

FIGS. 3A-3E illustrate operation of the bracket shown in FIG. 1 as the ligation cover is moved from the open, non-ligating position to the closed, ligating position;

FIG. 4A depicts an alternative exemplary orthodontic bracket according to the invention that includes a bracket base having a rounded surface that helps guide the bendable or flexible elongate film hinge to bend over substantially its entire length, with the ligation cover in an open position;

FIG. 4B depicts the bracket of FIG. 4B with the cover in a closed, ligating position;

FIG. 5A depicts a bracket including a bendable or flexible member comprising a spring-like bearing member disposed on an underside of the ligation cover, with the bearing member extended;

FIG. 5B depicts the bracket and bearing member of FIG. 5B in which the bearing member has been compressed, providing active ligation to the arch wire within the slot;

FIG. 6A is a perspective view of an alternative bracket including another bendable or flexible member;

FIG. 6B is a perspective view of the bracket base portion of the bracket of FIG. 6A; and

FIG. 6C is a cross-sectional view of the bracket of FIG. 6A.

### DETAILED DESCRIPTION OF THE PREFERRED EMBODIMENTS

### I. Introduction

The present invention is directed to orthodontic brackets having a bracket base including at least one arch wire slot formed therein, and at least one bendable or flexible member having a relatively thin cross-sectional thickness so as to facilitate flexing or bending of the member with little or no permanent deformation. At least the bendable or flexible member comprises an amorphous metallic alloy. The thinness of the bendable and/or flexible member formed of a glass-like amorphous metallic alloy surprisingly allows it to resiliently flex and bend, rather than fracture, as would be expected from an otherwise hard amorphous metallic alloy.

### II. Exemplary Orthodontic Brackets Including Bendable/Flexible Members

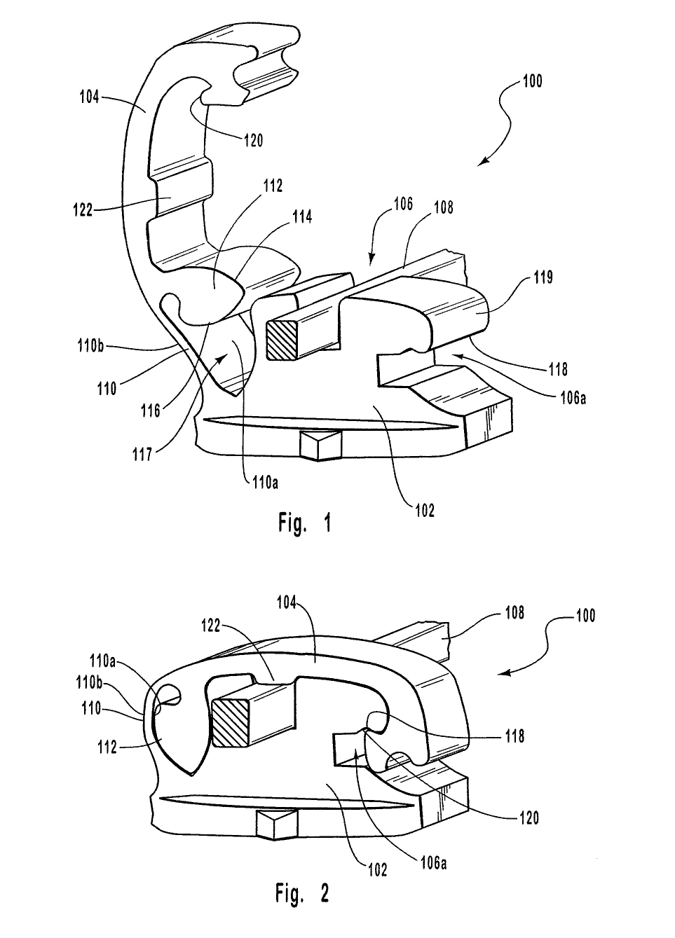

FIGS. 1 and 2 illustrate a self-ligating orthodontic bracket 100 including a bracket base 102 to which a ligation cover 104 is hingedly attached. An arch wire slot 106 open to the labial upper side of bracket base 102 is provided near the center of base 102 and serves for the receipt of an arch wire 108 therein. The arch wire 108, shown with a square cross-section (any other cross section known in the art could be used), is arranged inside the arch wire slot 106 and assists in providing the necessary forces to correct the teeth in a known manner. As illustrated in FIGS. 1 and 2, orthodontic bracket 100 may include an additional arch wire slot 106a. Ligation of an additional or alternate arch wire (not shown) may be accomplished in the same way as ligation of an arch wire in slot 106, i.e., by closing the ligation cover 104 over the bracket base 102.

Orthodontic bracket 100 further includes an elongate film hinge 110 that is attached at one end to the bracket base 102 and at an opposite end to the ligation cover 104. Film hinge 110 is characterized by a reduced cross-section relative to the adjacent bracket base 102 and ligation cover 104 to which it is attached at opposite ends of the elongate film hinge. Film hinge 110 is an example of a flexible or bendable member of bracket 100. Film hinge 110 is advantageously formed of an amorphous metallic alloy (e.g., LIQUID METAL). Such materials are amorphous, glass-like, and relatively hard and brittle. This is opposed to flexible, ductile, malleable traditional metals. A more detailed description of exemplary LIQUID METAL materials is given below. Although such materials are amorphous and generally brittle, the inventors have found that when formed in very small cross-sections (e.g., the thinness of elongate film hinge 110), the material rather exhibits a surprising degree of hardness and flexibility, allowing its use in forming elongate film hinge 110, which is required to resiliently bend and flex during use. When forming the entire bracket 100 from such an alloy, other portions of the bracket (e.g., portions of bracket base 102 defining slot 106) are provided with advantageous characteristics (e.g., excellent hardness and deformation resistance). By means of elongate film hinge 110, the ligation cover 104 is hingedly attached to the bracket base 104 and is able to be selectively rotated between an open, non-ligating position and a closed, ligating position relative to the bracket base 102, more particularly the arch wire slot 106. The ligation cover covers or occludes at least a portion of the arch wire slot 106 when in the closed, ligating position (see FIG. 2). The elongate film hinge 110 is a variation and improvement of an integral film hinge first disclosed in U.S. Pat. No. 6,607,383, hereby incorporated by reference.

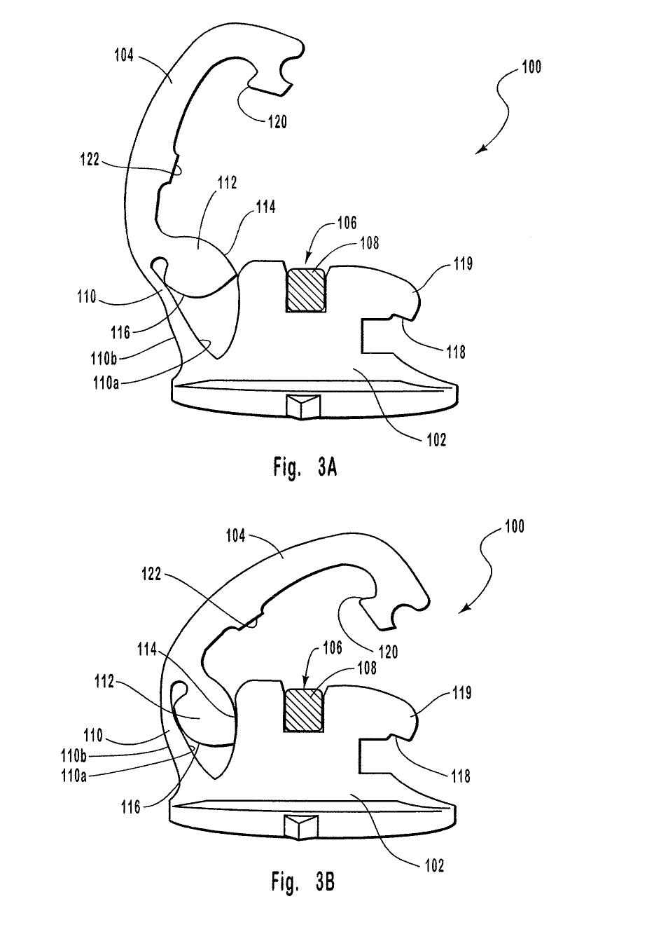

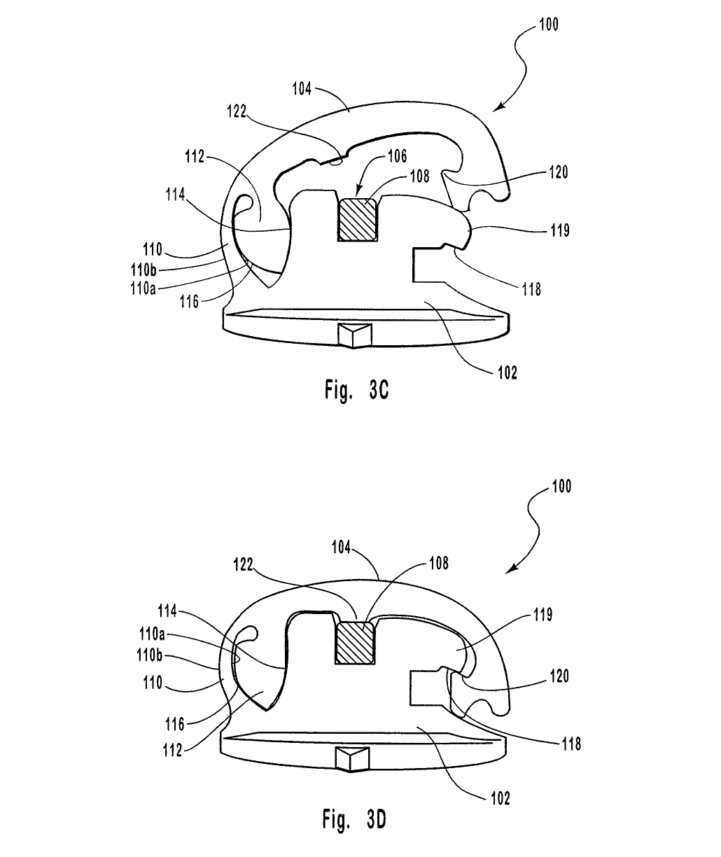

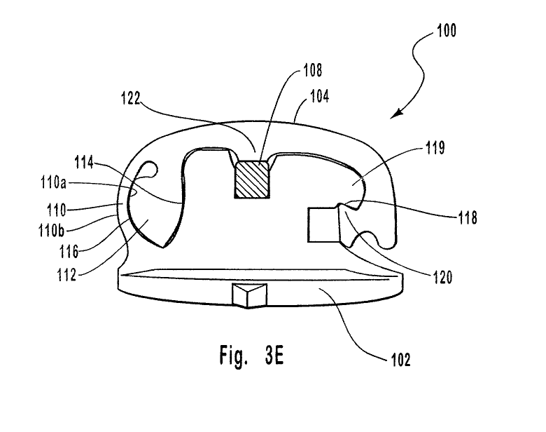

Because the film hinge 110 of orthodontic bracket 100 is elongated, it is able to bend gradually over a significant portion of its entire length rather than at a single point or line. This results in a hinge that is more resilient and durable over time because it is not overly bent or stressed at any particular point or line. Moreover, it is believed that because the elongate film hinge 110 can bend gradually over a significant portion of its entire length, this allows an otherwise brittle material to be used for its construction, so long as the cross-sectional thickness of the material is sufficiently thin to allow tensile and compressive stresses on the film hinge to remain below the tensile strength of the material. In other words, the inside surface 110a of elongate film hinge 110 is under compression during closing (e.g., as shown in FIGS. 3A-3E) and when completely closed. The outside surface 10b of elongate film hinge 110 is under tension during closing and when completely closed. Advantageously, because of the relatively thin cross-sectional dimensions of film hinge 110, as well as its overall bending length, the tensile strength of the material is not exceeded during this bending movement, allowing formation of the elongate film hinge, and optionally the whole bracket, from an amorphous metallic alloy.

In addition, ease of manufacture is possible as exemplary amorphous metallic alloys may be formed by molding the metal in a molten state, with little or no machining or cold working required. Such manufacture by molding is not possible with super-elastic flexible metal materials such as nickel-titanium alloys because cold working of the metal material is required in order to give the material its super-elastic properties. The ability to manufacture the bracket by molding as a single integral piece from an amorphous metallic alloy is a distinct advantage over a bracket of similar design formed of a nickel-titanium alloy. Manufacture can be less complex, less expensive, and results in a product with superior properties.

The elongate film hinge 110 is preferably constructed so as to bend along at least about 20% of its entire length, preferable along at least about 40% of its entire length, more preferably along at least about 60% of its entire length, and most preferably along at least about 80% of its entire length. In preferred embodiments, elongate film hinges of brackets according to the invention may bend along all or substantially all of their entire length.

In order to maximize strength while providing sufficient bendability, the elongate film hinges according to the invention are advantageously formed to have a thickness to provide for sufficient strength, but are also sufficiently thin so as to allow the hinge to bend with sufficient flexibility and resilience when in use. The inventors have found that elongate film hinges preferably having a thickness in a range of about 0.1 mm to about 0.4 mm, more preferably in a range of about 0.15 mm to about 0.3 mm, and most preferably in a range of about 0.2 mm to about 0.26 mm. In addition, the elongate film hinges preferably have a length that is at least about 3 times longer than average thickness, more preferably at least about 5 times longer than average thickness, and most preferably at least about 10 times longer than average thickness. For example, a configuration including a film hinge thickness of about 0.2 mm and a length of about 2 mm provides sufficient length along which the elongate film hinge may bend and flex from an open position to a closed position relative to the thinness of the film hinge. The tensile strength of the material is not exceeded, allowing a material otherwise considered to be brittle to be used in construction of the elongate film hinge and the bracket as a whole.

In some embodiments, the elongate film hinge will have a cross-sectional thickness that is less than the cross-sectional thicknesses of the adjoining ligation cover and bracket base. Nevertheless, it is within the scope of the invention for the elongate film hinge to have a material cross section that is as thick or thicker than the adjoining ligation cover and/or bracket base, so long as the thickness of the film hinge and its relative length is sufficiently thin and long to provide the necessary flexibility and bendability characteristics. In examples where the ligation cover is formed so as to be relatively thin, it too may exhibit flexibility. In such examples, the ligation cover itself may be an example of a bendable or flexible member. As described further below, flexibility of the cover may be helpful in locking and unlocking the cover from the base.

The elongate film hinge is preferably configured so that the ligation cover remains in an open, non-ligating position relative to the bracket base when the hinge is in a relaxed, unlocked condition. In one embodiment, the ligation cover remains open at least about 20° relative to the arch wire slot 106 of the bracket base when the hinge is in a relaxed condition, preferably at least about 45°, more preferably at least about 60°, and most preferably at least 90° relative to the arch wire slot. The ability of the ligation cover to remain in the open, non-ligating position without having to apply force to the ligation cover helps facilitate placement of an arch wire into the arch wire slot.

Whether or not the ligation cover remains open or whether it is closed relative to the bracket base when the elongate film hinge is in a relaxed condition, the elongate film hinge will generally be sufficiently flexible so as to permit the ligation cover to open to at least about 20° relative to the bracket base. In one embodiment, the elongate film hinge will be sufficiently flexible so as to permit the ligation cover to open at least about 40° relative to the bracket base. In another embodiment, the elongate film hinge will permit the ligation cover to open at least about 60°, preferably at least about 90°, more preferably at least about 160°, most preferably at least about 180° relative to the bracket base. In some cases, it may be desirable to open the ligation cover more than 180° relative to the bracket base (e.g., up to or exceeding 220°). Although the film hinge may allow extreme reverse (i.e., opening) rotation of the cover about the film hinge (e.g., up to or exceeding 220°), it is particularly advantageous that the cover tends to remain open to a significant degree on its own in a relaxed unlocked condition, without any applied force as this provides excellent sight lines and access to the practitioner when inserting or removing an arch wire from the arch wire slot. When the embodiment of FIGS. 1-2 is formed of an amorphous metallic alloy such as LIQUID METAL, the elongate film hinge 110 is advantageously biased to remain open to about 160° on its own, in a relaxed and unlocked condition. Biased open to such a large degree, the ligation cover is well out of the way of the practitioner when installing or removing an arch wire.

In one embodiment, the orthodontic bracket may include a curved surface that interacts with the elongate film hinge to assist in causing the hinge to bend gradually along a significant portion of its entire length as the ligation cover is selectively rotated relative to the bracket base. This curved surface preferably comprises an integral part of the ligation cover or bracket base, but may alternatively comprise a separate piece attached to the cover or bracket base. In one embodiment, the curved surface may be part of a cam structure that is integrally attached to the ligation cover, as illustrated in FIGS. 1 and 2.

In FIG. 1, a cam structure 112 is illustrated that has a camming surface 114 o, and a curved hinge-guiding surface 116. The hinge-guiding surface 116 is an example of a curved surface that interacts with the elongate film hinge 110 to assist in gradually bending the film hinge along a significant portion of its entire length as the ligation cover is rotated relative to the bracket base. The hinge-guiding surface 116 is advantageously curved so as to interact with the elongate film hinge 110 by distributing forces along a significant portion of its entire length as the ligation cover 104 is rotated. Distributing forces along a significant portion of the length of the elongate film hinge 110, rather than allowing the forces to concentrate at a single location, results in a hinged bracket that is more resistant to breakage of the film hinge compared to brackets in which the film hinge is bent abruptly at a specific point or line. Such a configuration is particularly beneficial where the film hinge is formed of an amorphous metallic alloy, as bending the film hinge over its full length reduces tension and compression forces at any given location, spreading the forces more or less evenly throughout the entire elongate film hinge.

In one embodiment, the hinge-guiding surface 116 may help maintain the ligation cover 104 (in combination with an exemplary latch mechanism discussed more fully below) in the locked position by exerting outward pressure against the elongate film hinge 110. This, in turn, effectively shortens the length of ligation cover 104, thereby causing the exemplary latch mechanism to hold the ligation cover 104 more tightly.

The camming surface 114 is curved or angled in such a way so that it interacts with the bracket base 102 in order to bias the ligation cover 104 toward the open, non-ligating position when the cover is in an unlocked configuration relative to the bracket base 102. This improves access to the arch wire slot 106, facilitating insertion or removal of an arch wire within the arch wire slot 106.

In the embodiment illustrated in FIG. 1, cam structure 112 is integrally attached to the inner surface of the ligation cover 104 in a manner so as to extend toward the bracket base 102. Further, and as is shown in particular in FIG. 2, the cam structure 112 is received within a recess 117 between the bracket base 102 and the elongate film hinge 110 when the ligation cover 104 is in the closed position. This results in a uniform smooth continuous surface along the top of the bracket 100. A uniform smooth and continuous surface results in greater safety and comfort for the patient, while also keeping food particles or other contaminants from becoming lodged in the bracket. The cam structure 112 also occupies the space 117 in order to displace debris that might otherwise lodge there. As cam structure 112 is required to flex and bend to a small degree during use, it may benefit from being formed from an amorphous metallic alloy. Cam structure 112 is another example of a bendable and/or flexible member that may be formed from an amorphous metallic alloy.

Orthodontic brackets according to the invention may advantageously include a locking system for maintaining the ligation cover 104 in a closed, ligating position once the cover has been closed relative to the bracket base. The illustrated embodiment shows an exemplary latch mechanism in which increased pressure by an arch wire 108 bearing upwardly against the ligation cover 104 results in tighter locking of the cover 104 to the bracket base 102. In the illustrated embodiment, an angled keyway 118 is provided near one end of the bracket base 102. The ligation cover 104 contains a corresponding locking tongue 120 that is insertable within the angled keyway 118. Alternative latch mechanisms, such as those disclosed in U.S. application Ser. No. 09/953,400, filed Sep. 12, 2001, now abandoned, may alternatively be used.

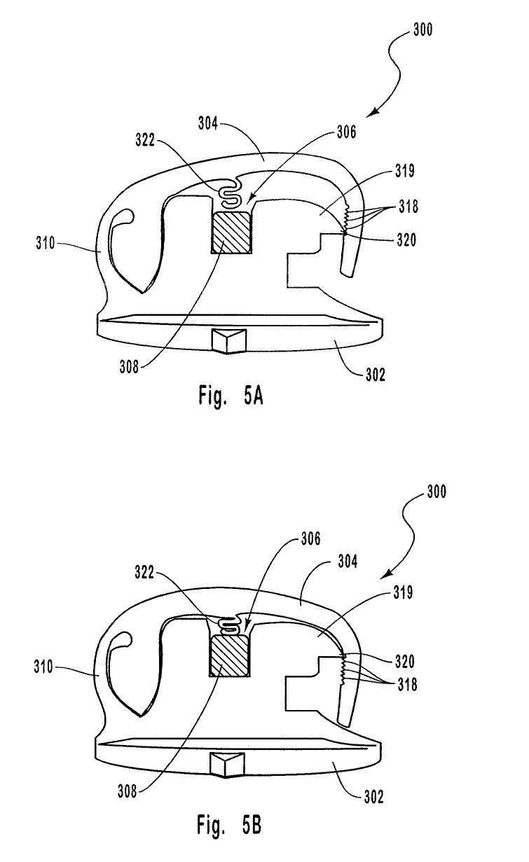

A bearing protrusion 122 may be provided on the inside and middle of the ligation cover 104 that extends toward the arch wire slot 106 when the ligation cover 104 is in the closed position. The bearing protrusion 122 assists in fixing the arch wire 108 within the arch wire slot 106 when the ligation cover is in the closed state (FIG. 2). The bearing protrusion 122 may provide for active ligation of arch wire 108 by pressing arch wire 108 lingually downward during use. Alternatively, the protrusion 122 and accompanying arch wire 108 may be sized so as to provide for a space between the arch wire 108 and either the bearing protrusion 122 or the lingual floor of slot 106. Such a configuration provides for passive ligation. An alternative bearing protrusion that comprises a spring-like member, and which may employ the flexible, bendable characteristics of thin amorphous metallic alloys is illustrated and described in conjunction with FIGS. 5A-5B, below.

FIG. 3A is a side view that shows the orthodontic bracket 100 with the ligation cover 104 in an open position relative to the bracket base 102, more significantly in a non-ligating position relative to the arch wire slot 106. The illustrated bracket 100 spontaneously opens when unlocked, i.e., it is biased to the open position. It will be appreciated, however, that, depending on the configuration of the elongate film hinge 110, it is possible for the ligation cover 104 to be biased either toward or away from the bracket base 102 when the ligation cover 104 is in a fully open position relative to the bracket base 102. In the embodiment shown in FIG. 3A the elongate film hinge 110 biases the ligation cover 104 so that the arch wire slot is easily accessible to the practitioner, and sight lines from the practitioner to the arch wire slot are unoccluded. As illustrated, the elongate film hinge comprising an amorphous metallic alloy biases to an open position where the angle between the lingual bonding pad surface of the bracket base 102 and the elongate film hinge is about 160°. Such a position provides excellent access to the arch wire slot 106 and good sight lines to the practitioner when installing and removing an arch wire. At 160° or more, the ligation cover 104 does not obstruct the view of the arch wire slot 106 from the vantage point of the practitioner. This tendency of the ligation cover 104 to remain in an open, non-ligating position absent external force is advantageous to the dental practitioner because it facilitates the insertion of an arch wire into the arch wire slot. It is easier for a dental practitioner to insert an arch wire into the arch wire slot 106 when using a bracket that spontaneously opens to a non-ligating position, as opposed to a bracket in which the ligation cover is continuously biased so as to cover or occlude the arch wire slot.

As seen in FIG. 3B, when the ligation cover 104 is pushed down toward the bracket base 102, the camming surface 114 of the cam structure 112 makes abutting contact with, and slides against, an upper surface of the bracket base 102, thereby causing the cam structure 112 to be biased in a spring-like fashion towards the elongate film hinge 110. As a result, the cam structure 112 can act as a spring that exerts an opposing biasing force that, in combination with the camming action of camming surface 114, biases or urges the ligation cover 104 toward the open, non-ligating position relative to the bracket base 102. Thus, if the bracket 100 is in the conformation depicted in FIG. 3B and the ligation cover 104 is released, it spontaneously springs back to a conformation like the one illustrated in FIG. 3A. It should be understood, however, that the exact resting conformation of the ligation cover 104 is dependent upon the properties of the specific amorphous metallic alloy from which elongate film hinge 110 is formed, as well as the size, shape and relative positions of the cam structure 112, the configuration of film hinge 110, and the upper surface of the bracket base 102 with which structure 112 comes into contact.

As the ligation cover 104 is pushed down further toward the bracket base 102 as seen in FIG. 3C, the camming surface 114 of the cam structure 112 continues to make contact with the bracket base 102, thus pushing the cam structure 112 further toward the elongate film hinge 110. Thus, if the bracket 100 is in the state depicted in FIG. 3C, and the ligation cover 104 is released, it will spontaneously spring back to a conformation like the one illustrated in FIG. 3A (subject to the specific amorphous metallic alloy employed, and size, shape and angles of the cam structure 112 and bracket base 102, and configuration of film hinge 110).

Additionally, when the bracket 100 is in the state illustrated in FIG. 3C, the curved hinge-guiding surface 116 of the cam structure 112 is in contact with the inside surface 110a of the elongate film hinge 110. This contact between curved surface 116 and the elongate film hinge 110 distributes compressive and tensile forces associated with closing the ligation cover 104 (i.e., while bending the hinge) gradually along at least the entire contact length between the curved surface 116 and the elongate film hinge 110 as the cover 104 is progressively closed. This results in the elongate film hinge 110 bending along its entire length, or at least a significant portion of its entire length, as the cover 104 is closed, rather than bending at a single point or line. This characteristic allows the elongate film hinge 110 to bend without kinking, thereby decreasing the likelihood of fatigue and unwanted breakage. This is particularly beneficial as the film hinge 110 comprises an otherwise relatively brittle material. Because bending forces are distributed throughout the hinge by surface 116 and cam structure 112, film hinge 110 can be significantly thicker than film hinges that do not include any associated structure for aiding distribution of bending forces along the length of the film hinge. Such film hinges may tend to bend at a discrete localized bending angle, which characteristic is more likely to result in fracture of the amorphous metallic alloy.

Also seen in FIG. 3C, the end of the ligation cover 104 containing the locking tongue 120 begins to make contact with the bracket base 102. As the ligation cover 104 is pushed further closed, the portion of the cover in contact with the base 102 slides along the upper side of the bracket base 102, which causes the ligation cover 104 to flex outwardly so that the locking tongue 120 can pass over the nose 119 of the bracket base 102 and into the angled keyway 118.

Further closing of the ligation cover 104 relative to the bracket base 102 causes the locking tongue 120 to be inserted within the angled keyway 118 (as shown in FIG. 3D). In the state depicted in FIG. 3D, the orthodontic bracket 100, more particularly the ligation cover 104, is locked in the closed, ligating position relative to the arch wire slot 106. It is believed that the thinness of the ligation cover 104 (e.g., about 0.4 mm to about 1 mm) relative to its length provides a small degree of flexibility, which allows the cover 104 to deform slightly as it passes over nose 119 and to resume its original shape once nose 119 has been cleared. As a result, the locking tongue 120 is pulled by the ligation cover 104 up into the angled keyway 118. In order to open the ligation cover 104, the locking tongue 120 may be physically pulled out of angled keyway 118 and over the nose 119 of the bracket base 102. Past that point, the ligation cover 104 will spontaneously open due to the spring-like action of the elongate film hinge 110. As ligation cover 104 is required to flex and bend to a small degree during use, it also may benefit from being formed from an amorphous metallic alloy. Ligation cover 104 is another example of a bendable and/or flexible member that may be formed from an amorphous metallic alloy.

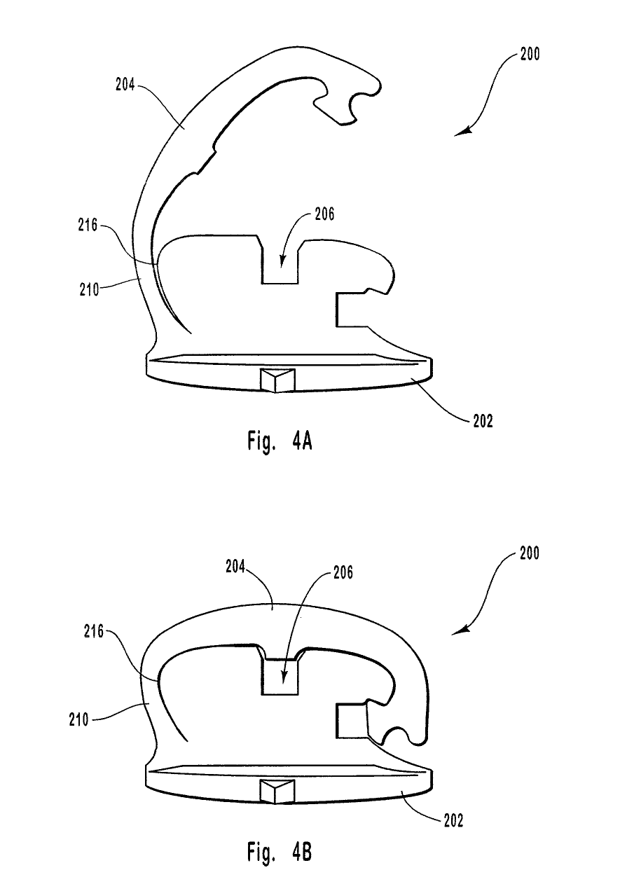

FIGS. 4A and 4B depict an alternative embodiment of an orthodontic bracket 200 according to the invention that does not include a cam structure. Instead, the orthodontic bracket 200 depicted in FIGS. 4A and 4B includes an arch wire slot 206 in a bracket base 202, and a ligation cover 204 attached to the bracket base 202 by means of an elongate film hinge 210. The bracket base 202 further includes a curved end 216 that acts as a hinge guide in order to cause the elongate film hinge 210 to bend gradually over a significant portion of its entire length. In this way, the curved end 216 of the bracket base 202 acts in similar manner to the curved hinge-guiding surface 116 of the cam structure 112 of the orthodontic bracket 100 depicted in FIGS. 1-3E. Thus, as the ligation cover 204 is moved from an open, non-ligating position (FIG. 4A) to a closed, ligating position (FIG. 4B), the elongate film hinge 210 at least partially abuts the curved end 216. The abutment between the elongate film hinge 210 and the curved end 216 causes the elongate film hinge 210 to bend gradually around the curved end 216 so as to better distribute the bending forces and bending angles along substantially the entire length of the elongate film hinge 210 that is formed from an amorphous metallic alloy.

FIGS. 5A-5B illustrate an alternative self-ligating orthodontic bracket 300 similar to bracket 100 which may also be molded as a single integral piece from an amorphous metallic alloy, but which includes a different arch wire bearing member and locking mechanism. Bracket 300 includes a bracket base 302, an arch wire slot 306, and a ligation cover 304 which is attached to bracket base by elongate film hinge 310. Cover 304 includes a serpentine spring-like bearing member 322. The bracket base 302 further includes a nose portion 319 with a locking protrusion 320. The locking protrusion 320 engages locking notches 318 formed within ligation cover 304. The plurality of locking notches 318 provide for varying locked positions of the ligation cover 304 relative to the base 302 in order to apply varying levels of pressure to the arch wire, and to allow the practitioner to select active or passive ligation of the arch wire.

Spring-like bearing member 322 extends from an inner surface of the cover 304 and is positioned so as to partially extend into the arch wire slot 306 when the cover 304 is in a locked or closed position relative to the base 302. The purpose of spring-like bearing member 322 is to provide downward lingual pressure onto arch wire 308 positioned within arch wire slot 306, or to at least retain it within slot 306. Spring-like bearing member 322 is formed of an amorphous metallic alloy, and because of the thin cross-section of the bearing member, it can be compressed or extended, depending on how completely arch wire 308 is seated within the arch wire slot 302 and which notch 318 engages protrusion 320. In other words, cover 304 may be pressed down more or less firmly to any desired locked position, according to the selection of the practitioner. As illustrated in FIG. 5A, passive ligation may be provided where cover 304 is latched (i.e., protrusion 320 engages a notch 318) and bearing member 322 does not contact arch wire 308. If active ligation is desired, cover 304 may be clicked down further lingually, causing protrusion 320 to latch within a more labially disposed notch 318 (see FIG. 5B). As shown, spring-like bearing member 322 is able to absorb forces from arch wire 308, causing bearing member 322 to compress.

Spring-like bearing member 322 is another example of a bendable or flexible member that may be formed of an amorphous metallic alloy. The cross-sectional thickness of bearing member 322 is sufficiently thin (e.g., about 0.02 mm to about 0.4 mm, more typically about 0.05 mm to about 0.15 mm) so as to allow the member 322 to bend and flex during use. The thinness of the cross-section of the bendable member may depend on the relative length of the member. In other words, the longer the length of the member along which bending forces are distributed, the thicker the cross-section may be, as the bending forces are reduced at any given location relative to a configuration where bending is more localized. Bearing member 322 is one example of a spring-like bearing member that may be formed of an amorphous metallic alloy. Preferably, the entire bracket is formed from such an alloy. Alternative spring-like bearing members and additional film hinges which may also be formed from thin cross-section amorphous metallic alloys are disclosed in U.S. Pat. No. 6,695,612, hereby incorporated by reference.

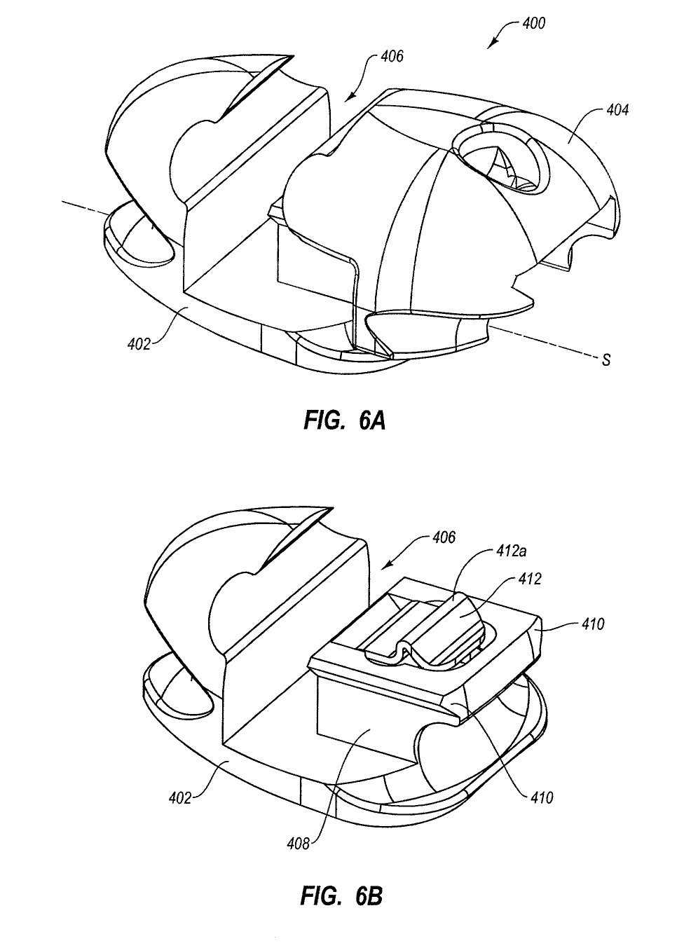

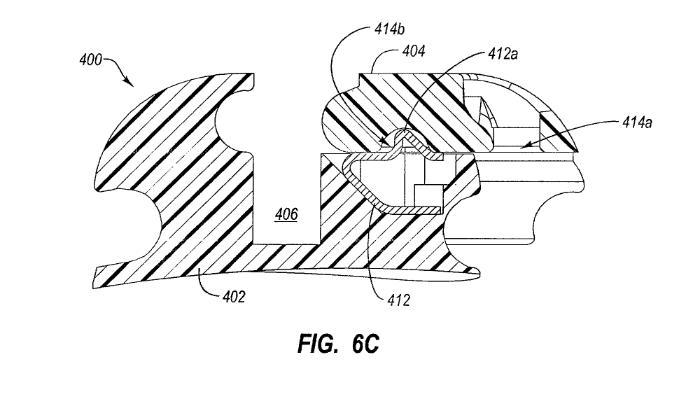

FIGS. 6A-6C illustrate another self-ligating bracket including a flexible or bendable member. The sliding cover and bracket base may be molded, machined, or otherwise formed separately and then assembled. Once assembled, the base 402 and cover 404 of bracket 400 are slidably connected to each other via a sliding joint mechanism defined by a sliding axis S along which ligation cover 404 can be slid from an open position to a completely closed and latched position. An arch wire slot 406 is provided in bracket base 402. As perhaps best seen in FIG. 6B, base 402 includes a sliding engagement mechanism for slidably coupling cover 404 to base 402. Illustrated base 402 includes a centrally disposed raised track 408 which extends labially from base 402. A pair of elongate rails 410 extend laterally from raised track 408. Rails 410 are oriented and aligned so as to be parallel with one another and to be parallel with axis S, defining a planar slide path. Elongate rails 410 and track 408 are configured to slidingly engage with corresponding structure formed on ligation cover 404.

Base 402 includes a separate resilient spring member 412. Spring member 412 is illustrated as a U-shaped clip, with one leg of the U being hidden within bracket base 402. This unseen leg of the clip serves to attach the clip to base 402. The hidden internal surface of cover 402 includes first and second depression grooves 414a, 414b configured to receive raised portion 412a of spring member 412. Raised portion 412a of spring member 412 is engaged within depression 414a when cover 404 is closed, and engages within depression 414b when cover 404 is open. The spring member 412 is a thin cross-section flexible member and may be formed of an amorphous metallic alloy, allowing it to exhibit sufficient resilient flexibility and bendability to allow raised portion 412a to deform by flattening lingually downward as the cover 404 moves from an open to a closed position, and vice-versa. The spring member 412 springs back labially upward when cover 404 is slid either fully open or fully closed so that raised portion 412a is aligned with either of the respective depressions formed in the underside of cover 404. Additional details regarding the bracket of FIGS. 6A-6C are disclosed in U.S. patent application Ser. No. 12/146,608 entitled SELF-LIGATING ORTHODONTIC BRACKET WITH SLIDING LIGATION COVER filed Jun. 26, 2008, hereby incorporated by reference.

The foregoing bracket examples describe various flexible and/or bendable members that may benefit from being formed of a thin cross-section of an amorphous metallic alloy. Examples of such flexible and/or bendable members include film hinges, spring-like bearing members, ligation covers, and latching mechanisms. Other such members will be apparent to one skilled in the art in light of the present disclosure.

Amorphous metallic alloys have an amorphous, rather than crystalline structure which is characteristic of metals traditionally used in formation of orthodontic brackets. Exemplary amorphous metallic alloys include, but are not limited to various alloys sold under the trade name LIQUID METAL, available from Liquidmetal Technologies in Rancho Santa Margarita, Calif. LIQUID METAL alloys are characterized as zirconium based metallic amorphous glasses formed from low purity materials. Preferred examples of these materials include the addition of a small amount of yttrium (Y). Disclosed examples of such materials are a combination of Zr, Al, Ni, Cu and Y or Zr, Ti, Ni, Cu, Be, and Y. Examples of LIQUID METAL alloys are disclosed in U.S. Pat. No. 6,682,611, incorporated herein by reference. Specific examples of LIQUID METAL amorphous glasses disclosed in U.S. Pat. No. 6,682,611 include (Zr₄₁Ti₁₄Cu_{12.5}Ni₁₀Be_{22.5})₉₈Y₂, (Zr₃₄T₁₅Cu_{12.5}Ni₁₁Be₂₈)₉₈Y₂, Zr₃₄Ti₁₅Cu₁₂Ni₁₁Be₂₈Y₂, (Zr₃₄Ti₁₅Cu₁₂Ni₁₁Be₂₈)₉₈Y₂, (Zr₃₄Ti₁₅Cu₁₀Ni₁₁Be_{22.5})₉₈Y₂, (Zr₅₅Al₁₅Ni₁₀Cu₂₀)₉₈Y₂, and (Zr₅₅Al₁₅Ni₁₀Cu₂₀)₉₆Y₄. Exemplary LIQUID METAL and other amorphous metallic alloys are harder than stainless steel or nickel-titanium alloys, preferably having a Rockwell C hardness of at least about 45, more preferably at least about 50. Exemplary LIQUID METAL alloys have a Rockwell C hardness of about 52. Such hardness is beneficial in the region of the bracket surrounding the arch wire slot as it results in increased resistance to wear and deformation.

The orthodontic brackets including a flexible or bendable member may advantageously be injection molded from a LIQUID METAL alloy or another amorphous metallic alloy that exhibits whatever degree of flexibility required by the flexible or bendable member when molded in very thin cross sections (e.g., such as an elongate film hinge). The ability to mold such a bracket from an amorphous metallic alloy is a distinct advantage over manufacturing methods requiring significant machining of the bracket. For example, some although preferred alloys are biocompatible, some may also contain materials (e.g., beryllium) known to be a health hazard when inhaled, and machining operations often result in airborne metal alloy dust. Such factors become important during manufacture.

Because super-elastic metal materials such as nickel-titanium require cold working in order to exhibit the super-elastic properties required of the flexible or bendable member (e.g., an elongate film hinge), it is not possible or at least practical to mold brackets from such materials in a single piece. The result is that a bracket formed from a Ni—Ti super elastic alloy (and other similar flexible metal materials) must be machined and cold worked to provide the needed flexibility. Providing an integral single piece metal bracket, which can be molded from an amorphous metallic alloy and exhibit the needed flexibility in the region of the flexible or bendable member (e.g., an elongate film hinge) without the need for any cold working or other significant post molding manufacture steps is a distinct advantage over a metal bracket of the same design, but which is formed of a flexible (e.g., Ni—Ti) metal which must be machined, cold worked, and assembled to exhibit the needed flexibility. Such additional steps add to the complexity and expense of manufacture.

In order to further streamline and reduce the complexity of manufacturing the brackets according to the present invention, the inventors have developed a manufacturing method by which the metal brackets may be molded while eliminating or minimizing the presence of attached runners and/or a sprue, which require machining steps for their removal. Advantageously, according to such molding methods, there is little or no excess metal (i.e., runners and/or a sprue) that remains adhered to the molded bracket when released from the mold. This reduces or eliminates the need for post molding finishing or machining. Reduction and/or elimination of finishing and/or machining steps (e.g., polishing, grinding, deburring) is particularly beneficial when working with LIQUID METAL alloys containing beryllium, as beryllium has been found to be carcinogenic. Additional details regarding such methods and apparatus are disclosed in a United States Patent Application bearing attorney docket number 7678.1087.3 entitled MOLD ASSEMBLY APPARATUS AND METHOD FOR MOLDING METAL ARTICLES, filed the same day as the present application. The above patent application is hereby incorporated by reference in its entirety.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An orthodontic bracket comprising:
a bracket base including at least one arch wire slot formed therein, the arch wire slot being adapted to receive an arch wire therein; and
a bendable or flexible member having a cross-sectional thickness to facilitate resilient flexing or bending of the member without breakage and with little or no permanent deformation, wherein at least the bendable or flexible member comprises an amorphous metallic alloy.

2. A self-ligating orthodontic bracket comprising:
a bracket base including at least one arch wire slot formed therein, the arch wire slot being adapted to receive an arch wire therein;
a ligation cover associated with the bracket base and selectively movable relative to the bracket base between an open, non-ligating position and a closed, ligating position; and
a bendable or flexible member having a cross-sectional thickness to facilitate resilient flexing or bending of the member without breakage and with little or no permanent deformation, wherein at least the bendable or flexible member comprises an amorphous metallic alloy.

3. A self-ligating orthodontic bracket as recited in claim 2, wherein the bendable or flexible member comprises a film hinge of reduced cross-sectional thickness connecting the bracket base to the ligation cover.

4. A self-ligating orthodontic bracket as recited in claim 2, wherein the bendable or flexible member comprises a spring-like bearing member disposed on an underside of the ligation cover.

5. A self-ligating orthodontic bracket as recited in claim 4, wherein the spring-like bearing member has a thickness in a range of about 0.02 mm to about 0.4 mm.

6. A self-ligating orthodontic bracket as recited in claim 1, wherein the amorphous metallic alloy is a zirconium based alloy.

7. A self-ligating orthodontic bracket as recited in claim 6, wherein the zirconium based amorphous metallic alloy comprises one alloy selected from the group consisting of (Zr₄₁Ti₁₄Cu_{12.5}Ni₁₀Be_{22.5})₉₈Y₂, (Zr₃₄Ti₁₅Cu_{12.5}Ni₁₁Be₂₈)₉₈Y₂, Zr₃₄Ti₁₅Cu₁₂Ni₁₁Be₂₈Y₂, (Zr₃₄Ti₁₅Cu₁₂Ni₁₁Be₂₈)₉₈Y₂, (Zr₃₄Ti₁₅Cu₁₀Ni₁₁Be_{22.5})₉₈Y₂, (Zr₅₅Al₁₅Ni₁₀Cu₂₀)₉₈Y₂, and (Zr₅₅Al₁₅Ni₁₀Cu₂₀)₉₆Y₄.

8. A self-ligating orthodontic bracket comprising:
a bracket base including at least one arch wire slot formed therein, the arch wire slot being adapted to receive an arch wire therein;
a ligation cover associated with the bracket base and selectively movable relative to the bracket base between an open, non-ligating position and a closed, ligating position; and
an elongate bendable or flexible film hinge attached at one end to the bracket base and at an opposite end to the ligation cover so as to hingedly connect the ligation cover to the bracket base, wherein at least the elongate bendable or flexible film hinge comprises an amorphous metallic alloy.

9. A self-ligating orthodontic bracket as recited in claim 8, wherein the amorphous metallic alloy comprises at least one of the compositions selected from the group consisting of (Zr₄₁Ti₁₄Cu_{12.5}Ni₁₀Be_{22.5})₉₈Y₂, (Zr₃₄Ti₁₅Cu_{12.5}Ni₁₁Be₂₈)₉₈Y₂, Zr₃₄Ti₁₅Cu₁₂Ni₁₁Be₂₈Y₂, (Zr₃₄Ti₁₅Cu₁₂Ni₁₁Be₂₈)₉₈Y₂, (Zr₃₄Ti₁₅Cu₁₀Ni₁₁Be_{22.5})₉₈Y₂, (Zr₅₅Al₁₅Ni₁₀Cu₂₀)₉₈Y₂, and (Zr₅₅Al₁₅Ni₁₀Cu₂₀)₉₆Y₄.

10. A self-ligating orthodontic bracket as recited in claim 8, wherein the elongate film hinge has a thickness in a range of about 0.1 mm to about 0.4 mm.

11. A self-ligating orthodontic bracket as recited in claim 8, wherein the elongate film hinge has a thickness in a range of about 0.15 mm to about 0.3 mm.

12. A self-ligating orthodontic bracket as recited in claim 8, wherein the elongate film hinge has a thickness in a range of about 0.2 mm to about 0.26 mm.

13. A self-ligating orthodontic bracket as recited in claim 12, wherein the elongate film hinge has a length at least about 10 times the thickness of the elongate film hinge.

14. A self-ligating orthodontic bracket as recited in claim 8, wherein the elongate film hinge biases the ligation cover to an open position such that the elongate film hinge forms an angle of at least about 90 degrees relative to the bracket base when open.

15. A self-ligating orthodontic bracket as recited in claim 8, wherein the elongate film hinge biases the ligation cover to an open position such that the elongate film hinge forms an angle of at least about 120 degrees relative to the bracket base when open.

16. A self-ligating orthodontic bracket as recited in claim 8, wherein the elongate film hinge biases the ligation cover to an open position such that the elongate film hinge forms an angle of at least about 160 degrees relative to the bracket base when open.

17. A self-ligating orthodontic bracket comprising:
a bracket base including at least one arch wire slot formed therein, the arch wire slot being adapted to receive an arch wire therein;
a ligation cover associated with the bracket base and selectively movable relative to the bracket base between an open, non-ligating position and a closed, ligating position; and
an elongate bendable or flexible film hinge attached at one end to the bracket base and at an opposite end to the ligation cover so as to hingedly connect the ligation cover to the bracket base;
wherein the bracket base, the ligation cover, and the film hinge are formed as a single integral piece comprising an amorphous metallic alloy.

18. A self-ligating orthodontic bracket as recited in claim 17, wherein the elongate film hinge has a thickness in a range of about 0.2 mm to about 0.26 mm.

19. A self-ligating orthodontic bracket as recited in claim 18, wherein the elongate film hinge has a length at least about 10 times the thickness of the elongate film hinge.

20. A self-ligating orthodontic bracket as recited in claim 19, wherein the elongate film hinge biases the ligation cover to an open position such that the elongate film hinge forms an angle of at least about 160 degrees relative to the bracket base.
